(19) United States
(12) Patent Application Publication
(10) Pub. No.: US 2016/0164926 A1
(43) Pub. Date: Jun. 9, 2016

(54) METHOD AND APPARATUS FOR INBOUND ROAMING OVER CELLULAR VOICE CHANNEL

(71) Applicant: Vonage Network LLC, Holmdel, NJ (US)

(72) Inventors: Boaz ZEHAVI, Jersey City, NJ (US); Soheil KARSHENAS NAJAFADABI, Kew Gardens, NY (US)

(21) Appl. No.: 14/558,823

(22) Filed: Dec. 3, 2014

(51) Int. Cl. H04L 29/06; H04W 60/04

(52) U.S. Cl. CPC H04L 65/1073; H04W 60/04

(57) ABSTRACT

An Internet Protocol (IP) telephony system comprises a radio communications interface and a processor. The processor is configured to execute a Communications over Internet Protocol (CoIP) application for an Internet Protocol (IP) telecommunication service; obtain an indication of a change of a Subscriber Identity Module (SIM) card of the mobile telephony device; and upon obtaining the indication of change, and generate, for sending over the radio communications interface, a registration message to the IP telecommunication service, the registration message including a new International Mobile Subscriber Identity (IMSI) for the mobile telephony device.

### TECHNICAL FIELD

The technology relates to telecommunications, and in particular to Internet Protocol (IP) telephone systems that are accessible to mobile telephony devices.

### BACKGROUND

An Internet Protocol (IP) telephony system routes various types of communications, at least in part, via data packets that are communicated over a data network. The data network is commonly the Internet. The types of communications may be, for example, telephone calls, video calls, text and video messages, and other forms of telephony and data communications. The users of the Internet Protocol (IP) telephony system typically gain access to the Internet using an Internet service provider so that they can communicate via the IP telephony system.

Some users or customers of the IP telephony system may engage in communications using telephony devices that are connected by physical lines such as cables or wires to an access point such as an internet port. Such wired telephony devices may, thanks to the services of the IP telephony system, be moved from one physical location to another physical location, but at each such physical location are physically connected in a wired manner to the respective access point.

Other users or customers of the IP telephony system may possess mobile or wireless telephony devices, such as a wireless terminal, user equipment (UE), mobile phone, smart phone, or laptop, tablet, or other device with mobile termination. When such a mobile telephony device is within coverage of an appropriate wireless network (e.g., WiFi or WiMax network) that has connection to the a data network such as the Internet, the communications involving the mobile telephony device may be handled by the IP telephony system in conjunction with the wireless network. In other words, the communications may occur wirelessly between the mobile telephony device and a wireless access point of the wireless network, with the wireless access point in turn being connected to an Internet portal. Access in this manner to the Internet portal enables the mobile telephony device to capitalize upon the service of the IP telephony system in economically routing the communications through the Internet, rather than over existing non-Internet service carriers.

When a mobile telephony device is not in range of a wireless network to gain the benefit of the IP telephony system, the mobile telephony device may instead be served by other carriers and/or services using one or more mobile radio access networks. Such mobile radio access networks typically comprise plural base stations which have both radio frequency transmitting and receiving capabilities to serve macro cells. A macro cell is essentially defined by the extent of the transmitting and receiving capabilities of the base station. The mobile telephony devices located within the cell may communicate with the radio access network through the base station (unless the customer also happens to be within range of another wireless network, such as a WiFi or WiMax wireless network or the like, and exercises the option to use the other wireless network instead of the radio access network). In some instances such a “macro” base station may be called a “radio base station”, “base station”, NodeB, eNodeB, or the like.

Many radio access networks allow a mobile telephony device to roam from cell to cell, either within the same radio access network and radio access technology, or even to roam between cells of differing radio access networks and/or radio access technologies. Such roaming between cells and/or technologies of radio access networks typically involves an operation or procedure known as “location update”, or some similar operation. Method and apparatus for roaming are described in U.S. Pat. No. 8,600,364; U.S. patent application Ser. No. 12/987,559, filed Jan. 10, 2011; U.S. patent application Ser. No. 14/291,566, filed May 30, 2014; and U.S. patent application Ser. No. 14/333,490, filed Jul. 16, 2014, all of which are incorporated herein by reference in their entireties.

Some IP telephony systems enable their customers to place low-cost international calls to foreign countries, and do so by connection of the international inbound calls over a data channel by terminating the international inbound calls to an IP address. But there may be instances in which an IP telephony system is not able to connect a call over a data channel to a roaming customer, e.g., to a customer roaming in a foreign country. For example, there may be no data connection at the site of the roaming customer (e.g., no data connection in a certain region of the foreign country), or the data connection may be of insufficient quality to support the data call.

### SUMMARY

In one of its aspects the technology disclosed herein concerns a method of operating a mobile telephony device. The method comprises executing, on a processor of the mobile telephony device, a Communications over Internet Protocol (CoIP) application for an Internet Protocol (IP) telecommunication service. The method further comprises obtaining an indication of a change of a Subscriber Identity Module (SIM) card of the mobile telephony device; and upon obtaining the indication of the change. The method also comprises sending an update registration message to the IP telecommunication service, the registration message including a new International Mobile Subscriber Identity (IMSI) for the mobile telephony device.

In an example embodiment and mode the method further comprises, prior to obtaining the indication of the change of the Subscriber Identity Module (SIM) card, sending a previous registration message including a previous International Mobile Subscriber Identity (IMSI) for the mobile telephony device to the Internet Protocol (IP) telecommunication service.

In an example embodiment and mode obtaining the indication of the change of the Subscriber Identity Module (SIM) card of the mobile telephony device comprises receiving an indication of the change of the Subscriber Identity Module (SIM) card from a user through a user interface of the telephony device.

In an example embodiment and mode obtaining the indication of the change of the Subscriber Identity Module (SIM) card of the mobile telephony device comprises the telephony device automatically detecting the change of the Subscriber Identity Module (SIM).

In an example embodiment and mode the method further comprises obtaining the indication of the change of the Subscriber Identity Module (SIM) card when the Communications over Internet Protocol (CoIP) application is opened.

In an example embodiment and mode the method further comprises including in the registration message an account identifier allocated by the Internet Protocol (IP) telecommunication service.

In another of its aspects the technology disclosed herein concerns an Internet Protocol (IP) telephony system comprising a radio communications interface and a processor. The processor is configured to execute a Communications over Internet Protocol (CoIP) application for an Internet Protocol (IP) telecommunication service; obtain an indication of a change of a Subscriber Identity Module (SIM) card of the mobile telephony device; and upon obtaining the indication of change, and generate, for sending over the radio communications interface, a registration message to the IP telecommunication service, the registration message including a new International Mobile Subscriber Identity (IMSI) for the mobile telephony device.

In an example embodiment and mode the processor is further configured to send, prior to obtaining the indication of the change of the Subscriber Identity Module (SIM) card, a previous registration message including a previous International Mobile Subscriber Identity (IMSI) for the mobile telephony device to the Internet Protocol (IP) telecommunication service.

In an example embodiment and mode the mobile telephony device further comprises a user interface, and the processor is configured to obtain the indication of the change of the Subscriber Identity Module (SIM) card of the mobile telephony device by receiving an indication of the change of the Subscriber Identity Module (SIM) card from a user through the user interface.

In an example embodiment and mode the processor is configured to obtain the indication of the change of the Subscriber Identity Module (SIM) card of the mobile telephony device by automatically detecting the change of the Subscriber Identity Module (SIM).

In an example embodiment and mode the processor is configured to obtain the indication of the change of the Subscriber Identity Module (SIM) card when the Communications over Internet Protocol (CoIP) application is opened.

In an example embodiment and mode the processor is configured to include in the registration message an account identifier allocated by the Internet Protocol (IP) telecommunication service.

In another of its aspects the technology disclosed herein concerns a method of operating an internet-based telephony system. In a basic embodiment and mode the method comprises receiving a registration message from a mobile telephony device, the registration number including an International Mobile Subscriber Identity (IMSI) and account identifier allocated or accorded by the Internet Protocol (IP) telecommunication service to the telephony device; making a determination that the IMSI included in the registration message indicates a change in IMSI for the mobile telephony device; and, based on the determination, forwarding an incoming call for the account identifier to a calling number associated with the IMSI included in the registration message.

In an example embodiment and mode the method further comprises sending the IMSI included in the registration message to a home network associated with the IMSI included in the registration message; obtaining the calling number associated with the IMSI from the home network associated with the IMSI included in the registration message; and thereafter forwarding the incoming call for the account identifier to the calling number so that the incoming call is terminated over a cellular network.

In an example embodiment and mode the method further comprises making a previous recognition determination that the internet-based telephony system has previously associated the IMSI included in the registration message with a stored calling number associated with the IMSI; and, based on the previous recognition determination using the stored calling number as the calling number.

In an example embodiment and mode the method further comprises sending the IMSI included in the registration message to a home network associated with the IMSI included in the registration message; receiving an indication that the home network associated with the IMSI included in the registration message is not able to provide the calling number associated with the IMSI; and in accordance with the indication, sending a message to the mobile telephony device to request the calling number for forwarding the incoming call.

In an example embodiment and mode the method further comprises making an invalidity determination that the registration message does not include a valid IMSI; and based on the invalidity determination sending a message to the mobile telephony device to request the calling number for forwarding the incoming call.

In another of its aspects the technology disclosed herein concerns another method of operating an internet-based telephony system. In a basic mode the method comprises receiving a registration message from a mobile telephony device, the registration number including an International Mobile Subscriber Identity (IMSI) and account identifier allocated by the Internet Protocol (IP) telecommunication service to the telephony device; making a determination that the IMSI included in the registration message is invalid; and, based on the determination, sending a message to the mobile telephony device to request the calling number for forwarding the incoming call.

In another of its aspects the technology disclosed herein concerns an internet-based telephony system comprising a processor. The processor is configured to receive a registration message from a mobile telephony device, the registration number including at least a portion of an International Mobile Subscriber Identity (IMSI) and account identifier allocated by the Internet Protocol (IP) telecommunication service to the telephony device; to make a determination that the IMSI included in the registration message indicates a change in IMSI for the mobile telephony device; and, based on the determination, forward an incoming call for the account identifier to a calling number associated with the IMSI included in the registration message.

In an example embodiment and mode the processor is further configured to: send the IMSI included in the registration message to a home network associated with the IMSI included in the registration message; obtain the calling number associated with the IMSI from the home network associated with the IMSI included in the registration message; and thereafter forward the incoming call for the account identifier to the calling number so that the incoming call is terminated over a cellular network.

In an example embodiment and mode the processor is further configured to: make a previous recognition determination that the internet-based telephony system has previously associated the IMSI included in the registration message with a stored calling number associated with the IMSI; and, based on the previous recognition determination use the stored calling number as the calling number.

In an example embodiment and mode the processor is further configured to: make an invalidity determination that the registration message does not include a valid IMSI; and based on the invalidity determination, send a message to the mobile telephony device to request the calling number for forwarding the incoming call.

In an example embodiment and mode the processor is further configured to: make an invalidity determination that the registration message does not include a valid IMSI; and based on the invalidity determination, send a message to the mobile telephony device to request the calling number for forwarding the incoming call.

In another of its aspects the technology disclosed herein concerns an internet-based telephony system comprising a processor configured to: receive a registration message from a mobile telephony device, the registration number including an International Mobile Subscriber Identity (IMSI) and account identifier allocated by the Internet Protocol (IP) telecommunication service to the telephony device; make a determination that the IMSI included in the registration message is invalid; and, based on the determination, send a message to the mobile telephony device to request the calling number for forwarding the incoming call.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of a communications environment including various elements which are associated with an Internet protocol (IP) telephony system operating in accordance with an example embodiment.

FIG. 2 is a diagrammatic view of various elements of computer equipment that may comprise either an IP telephony system or telephony device in accordance with example embodiments.

FIG. 3 is a diagrammatic view of a communications network comprising an Internet-based telephony system which facilitates roaming, showing location/situation of a telephony device in various roaming positions.

FIG. 4A is a schematic view of a telephony device according to an example embodiment; FIG. 4B is a schematic view showing a telephony device in more detail according to an example implementation.

FIG. 5 is a schematic view of an IP telephony system according to an example embodiment.

FIG. 6 is a diagrammatic view depicting change or replacement of an old SIM card with a new or “replacement” SIM card.

FIG. 7 is a flowchart showing example, representative acts or steps performed by a telephony device in accordance with example embodiments of the technology disclosed herein.

FIG. 8 is a flowchart showing example, representative acts or steps that may be performed by a telephony device when executing a SIM card registration procedure according to an example embodiment and mode.

FIG. 9 is a flowchart showing example, representative acts or steps that may be performed by an IP telephony system such as IP telephony system according to an example embodiment and mode.

FIG. 10A, FIG. 10B, and FIG. 10C, and FIG. 10D are flowcharts showing example, representative acts or steps that may be performed by an IP telephony system when executing a SIM card registration acknowledgment procedure according to a different example embodiments and modes.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

In this description, the terms “VoIP system”, “VoIP telephony system”, “IP system” and “IP telephony system” are all intended to refer to a system that connects callers and that delivers data, text and video communications using Internet protocol data communications.

This description refers to “telephony communications”. The term “telephony communications” is intended to encompass any type of communication that could pass back and forth between users of an IP telephony system. This includes audio and video telephone, text messages such as short message service (SMS) communications, video messages and any other form of telephony or data communication.

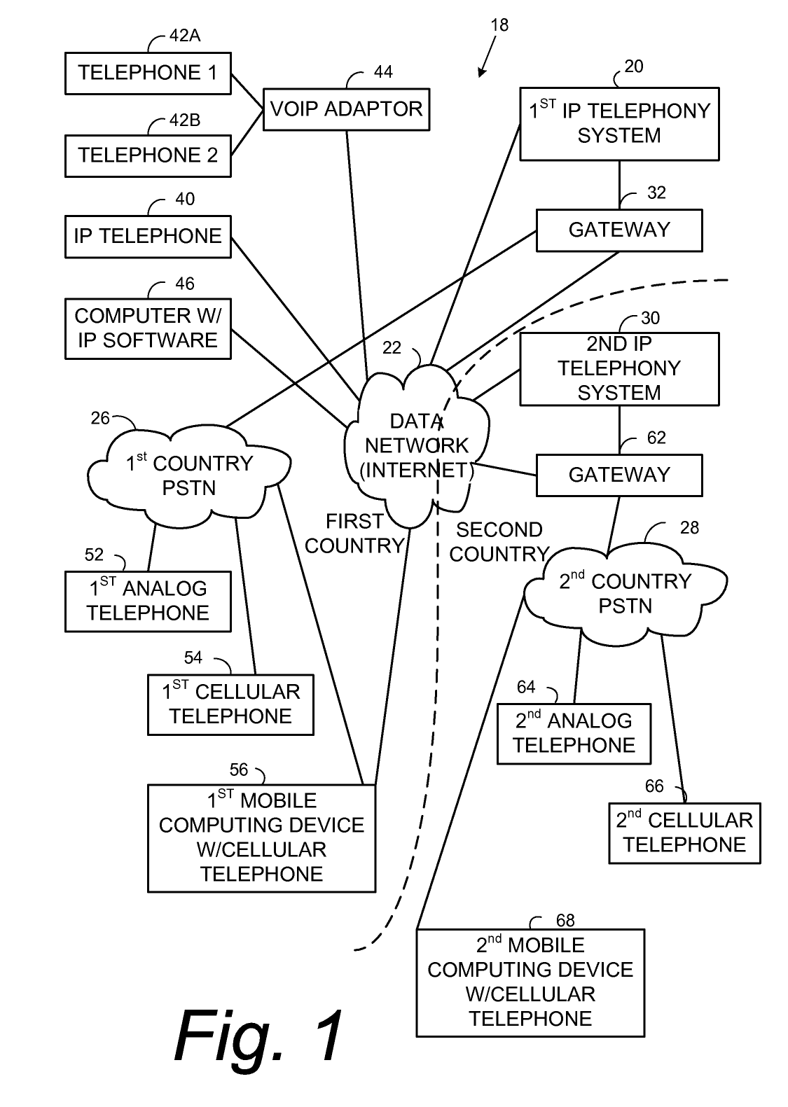

As illustrated in FIG. 1, a communications environment 18 is provided to facilitate IP based communications. A first IP telephony system 20 enables connection of telephone calls between its own customers and other parties via data communications that pass over a data network. The data network is commonly the Internet 22, however, private data networks may form all or a portion of the data communication path. The first IP telephony system 20 is connected to the Internet 22.

In addition, the first IP telephony system 20 is connected to a first publicly switched telephone network (PSTN) 26, a second PSTN 28, and a second IP telephony system 30. This allows the first IP telephony system 20 to receive telephony communications from and send telephony communications to each of these other communications systems. In some instances, the first IP telephony system 20 would receive an incoming communication directed to one of its own customers from one of these other communications system. The first IP telephony system 20 then terminates the call to the customer's telephony device. In other instances, the first IP telephony system may setup an outgoing call from one of its customers to a customer of one of these other communications systems. In still other instances, the first IP telephony system 20 may act as an intermediate party to connect a communication between two of these other communications systems.

In some instances, the first IP telephony system 20 accesses the Internet 22 via a gateway 32. The gateway 32 allows users and devices that are connected to the first and second PSTNs 26, 28 and/or the second IP telephony system 30 to connect with users and devices that are reachable through the first IP telephony system 20, and vice versa. In some instances, the gateway 32 would be a part of the first IP telephony system 20. In other instances, the gateway 32 could be maintained by a third party.

Customers of the first IP telephony system 20 can place and receive telephone calls using an IP telephone 40 that is connected to the Internet 22. Such an IP telephone 40 could be connected to an Internet service provider via a wired connection or via a wireless router. In some instances, the IP telephone 40 could utilize a cellular telephone system to access the Internet 22.

Alternatively, a customer could utilize an analog telephone 42A which is connected to the Internet 22 via terminal adapter 44. The terminal adapter 44 converts analog signals from the telephone 42A into data signals that pass over the Internet 22, and vice versa. Also, as illustrated in FIG. 1, multiple analog telephones 42A and 42B could all be coupled to the same terminal 44. Analog telephone devices include, but are not limited to, standard telephones and document imaging devices such as facsimile machines. A configuration using a terminal adapter 44 is common where all of the analog telephones 42A, 42B are located in a residence or business, and all of the telephones are connected to the same terminal adapter. With this configuration, all of the analog telephones 42A, 42B share the same telephone number assigned to the terminal 44. Other configurations are also possible where multiple communication lines (e.g., a second telephone number) are provisioned by the IP telephony system 20.

In addition, a customer could utilize a soft-phone client running on a computer 46 to place and receive IP based telephone calls, and to access other IP telephony systems. In some instances, the soft-phone client could be assigned its own telephone number. In other instances, the soft-phone client could be associated with a telephone number that is also assigned to an IP telephone 40, or to a terminal 44 that is connected to one or more analog telephones 42A, 42B.

A third party using first analog telephone 52 which is connected to the first PSTN 26 may call a customer of the IP telephony system 20. In this instance, the call is initially connected from the first analog telephone 52 to the first PSTN 26, and then from the first PSTN 26, through the gateway 32 to the first IP telephony system 20. The first IP telephony system 20 then routes the call to the customer's IP telephony device. A third party using first cellular telephone 54 could also place a call to an IP telephony system customer, and the connection would be established in a similar manner, although the first link would involve communications between the first cellular telephone 54 and a cellular telephone network. For purposes of this explanation, the cellular telephone network is considered part of the first PSTN 26.

In addition, mobile computing devices which include cellular telephony capabilities could also be used to place telephone calls to customers of the IP telephony system. A first mobile computing device 56, as illustrated in FIG. 1, might connect to the first PSTN 26 using its cellular telephone capabilities. However, such devices might also have the ability to connect wirelessly via some other means. For example, the mobile computing device 56 might communicate with a wireless data router to connect the first mobile computing device 56 directly to a data network, such as the Internet 22. In this instance, communications between the first mobile computing device 56 and other parties could be entirely carried by data communications which pass from the first mobile computing device 56 directly to data network 22. Of course, alternate embodiments could utilize any other form of wired or wireless communications path to enable communications.

Users of the first IP telephony system 20 are able to access the service from virtually any location where they can connect to the Internet 22. Thus, a customer could register with an IP telephony system located in the United States, and that customer could then use an IP telephone located in a country outside the United States to access the services. Likewise, the customer could also utilize a computer outside the U.S. that is running a soft-phone client to access the first IP telephony system 20. Further, in some instances a user could place a telephone call with the first analog telephone 52 or first cellular telephone 54 that is routed through the first PSTN 26 to the first IP telephony system 20 via the gateway 32. This would typically be accomplished by the user calling a local telephone number that is routed to the first IP telephony system 20 via the gateway 32. Once connected to the first IP telephony system 20, the user may then place an outgoing long distance call to anywhere in the world using the first IP telephony system's network. Thus, the user is able to place a long distance call using lower cost IP telephony service provided by the first IP telephony system 20, rather than a higher cost service provided by the first PSTN 26.

FIG. 1 also illustrates that second IP telephony system 30 may interact with the first IP telephony system 20 via the Internet 22. For example, customers of the second IP telephony system 30 may place calls to customers of the first IP telephony system 20. In that instance, assets of the second IP telephony system 30 interact with assets of the first IP telephony system 20 to setup and carry the telephone call. Conversely, customers of the first IP telephony system 20 can place calls to customers of the second IP telephony system 30. The second IP telephony system could also interact with the other communications systems via gateway 62.

As illustrated in FIG. 1, the second PSTN 28 may be connected to second analog telephone 64, second cellular telephone 66, and second mobile computing device 68.

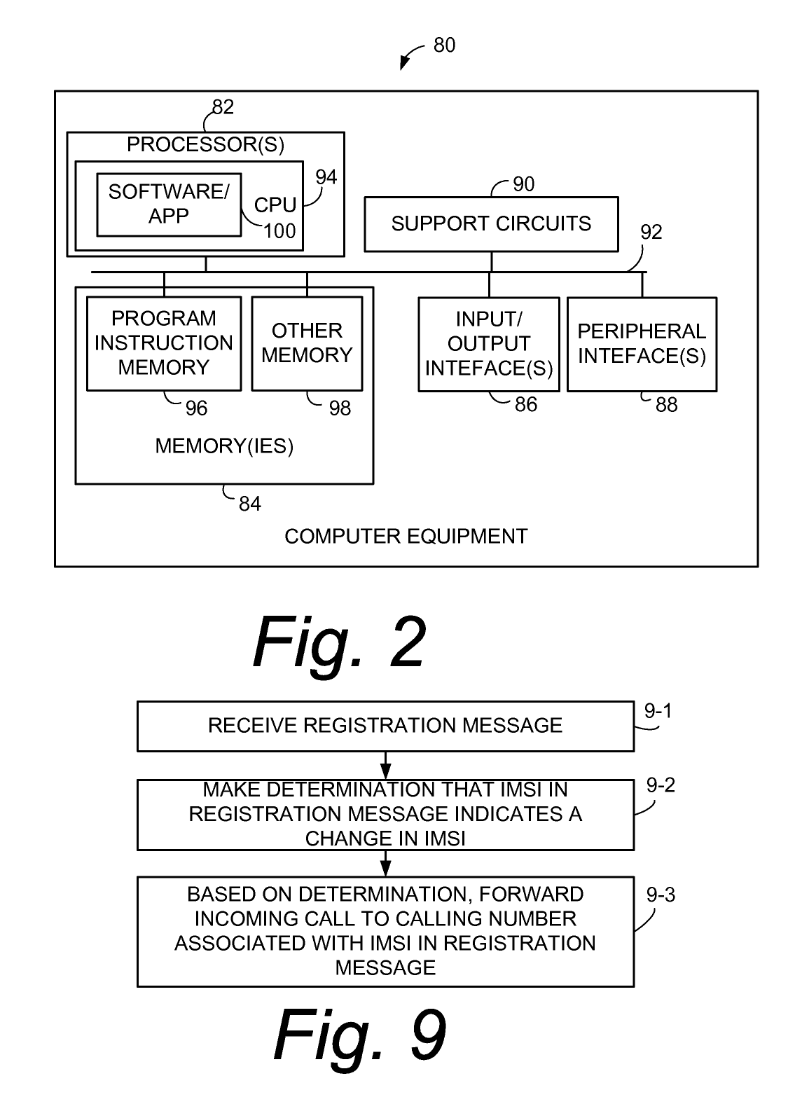

FIG. 2 illustrates elements of machine hardware 80 that may be used as part of the first or second IP telephony systems 20, 30, or as part of an IP telephony device, to accomplish various functions. In the illustrated example embodiment, the machine hardware 70 comprises a computer, e.g., computer equipment, but in other example embodiments the machine hardware 70 may instead comprise or encompass, without limitation, digital signal processor (DSP) hardware, reduced instruction set processor, hardware (e.g., digital or analog) circuitry including but not limited to application specific integrated circuit(s) (ASIC), and/or field programmable gate array(s) (FPGA(s)), and (where appropriate) state machines capable of performing such functions.

FIG. 2 shows an example of such machine hardware 80 as comprising one or more processors 82; memory(ies) 84; input/output interfaces 86; peripheral interfaces 88; support circuits 90; and buss(es) 92 for communication between the aforementioned units.

Each of the IP telephony systems 20, 30, or an IP telephony device, may include multiple processors 82, along with their operating components and programming, each carrying out a specific or dedicated function. The processor 82 shown in FIG. 2 may be one of any form of a general purpose computer processor used in accessing an IP-based network, such as a corporate intranet, the Internet or the like. The processor 82 comprises one or more central processing units (CPUs) 94.

The memory(ies) 84 may comprise memory such as program instruction memory 96 and other memory 98 (e.g., RAM, cache, etc.). The memory(ies) 84 may comprise computer-readable medium, and may be one or more of readily available memory such as random access memory (RAM), read only memory (ROM), floppy disk, hard disk, flash memory or any other form of digital storage, local or remote, and is preferably of non-volatile nature.

The support circuits 90 are coupled to the processor 82 for supporting the processor in a conventional manner. These circuits may include cache, power supplies, clock circuits, input/output circuitry and subsystems, and the like

The input/output interfaces 86 serve to connect the processor 82 to customer equipment, to service provider equipment, to IP network or gateways, as well as possibly one or more input/output devices (not shown) for accessing the processor and/or performing ancillary or administrative functions related thereto.

The buss(es) 92 may comprise plural or a single bus structure, with numerous buss configurations being possible without degrading or otherwise changing the intended operability of the processor 82.

One or more software routines or software programs are normally stored in program instruction memory 96. Some of the software routines or software programs may be referred to as “applications”. FIG. 2 shows one such software routine or software program 100 as being loaded from program instruction memory 96 into CPU 94 so that the software program 100 is executed by CPU 94. Execution of the software program 100 causes the processor 82 to perform processes of the disclosed embodiments. The software routine 100 may also be stored and/or executed by a second CPU (not shown) that is remotely located from the hardware being controlled by the CPU 94. Also, the software routines could also be stored remotely from the CPU. For example, the software could be resident on servers and memory devices that are located remotely from the CPU, but which are accessible to the CPU via a data network connection.

The software routine 100, when executed by the CPU 94, transforms the general purpose computer into a specific purpose computer that performs one or more functions of an IP telephony system 20/30 or an IP telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 100 of the disclosed embodiments is capable of being executed on any computer operating system, and is capable of being performed using any CPU architecture.

In this description references are made to an “IP telephony device” or “telephony device”. These terms are used to refer to any type of device which is capable of interacting with an IP telephony system to complete a telephone call. An IP telephony device could be an IP telephone, a computer running IP telephony software, a terminal adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

This description also refers to a mobile telephony device. The term “mobile telephony device” is intended to encompass multiple different types of devices. In some instances, a mobile telephony device could be a cellular telephone. In other instances, a mobile telephony device may be a mobile computing device that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an Apple iPhone™, a RIM Blackberry or a comparable device running Google's Android operating system could be a mobile telephony device.

In still other instances, a mobile telephony device may be a device that is not traditionally used as a telephony device, but which includes a wireless data transceiver that can establish a wireless data connection to a data network. That is, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

This description also refers to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

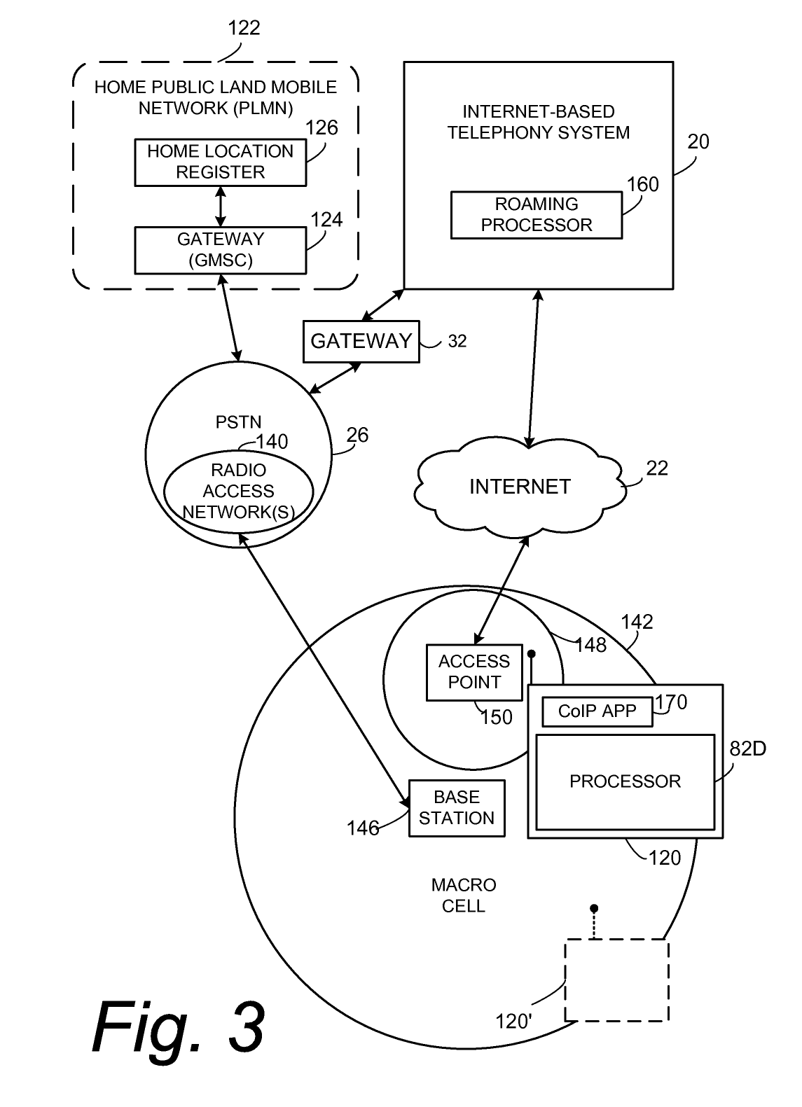

FIG. 3 again shows IP telephony system 20 being connected to a data communications network such as Internet 22. A telephony device 120, which for sake of illustration happens to be a mobile or wireless telephony device such as a user equipment unit, smart phone, or laptop with mobile termination, for example, is associated with a customer of the telephony system 20. The customer is not only a customer of telephony system 20, but is also served by the customer's home public land mobile network (PLMN) 122. The customer's home public land mobile network 122 is shown in FIG. 3 as comprising a PLMN gateway or mobile switching center (GMSC) 124, as well as a PLMN home location register (HLR) 126.

Both home public land mobile network 122 and telephony system 20 are connected to the public switched telephone network (PSTN) 26. The public switched telephone network (PSTN) 26 may comprise one or more radio access network(s) (RANs) 140. The home public land mobile network 122 is connected to public switched telephone network (PSTN) 40 through the GMSC 124. Telephony system 20 is also connected to public switched telephone network (PSTN) 26 through its gateway 32.

FIG. 3 further shows telephony device 120 as being situated in a radio access network cell 142 which is served by base station 146 of a radio access network 140. The base station 146 may be a base station controller (BSC), NodeB, eNodeB, or other type of base station. As such, the network cell 142 may be referred to as a macro cell and the base station 146 as a macro base station. Typically macro base stations such as macro base station 146 communicate with wireless terminals using licensed frequencies.

It will be appreciated that some macro base stations belong to networks which have data connection handling capability while other base stations belong to networks that do not have data connection handling capability. The former networks provide services such as call service and short message service (SMS), and typically include base stations which report to a radio network controller node and which may belong to a roaming area. The former networks may additionally provide General Packet Radio Service (GPRS)/3G/LTE services and typically include base stations characterized as NodeB or eNodeB and for which routing areas are defined. The base stations of both types of networks broadcast their roaming and routing area.

FIG. 3 also shows telephony device 120 as being within a smaller cell 148 (e.g., a micro cell, home cell, pico cell, or femto cell) which is served by a wireless access point 150 of an internet-connected wireless access service. The access point 150 may provide Wi-Fi or WiMAX access to telephony device 120. Wi-Fi is a technology that allows an electronic device to exchange data or connect to the Internet wirelessly using microwaves in the 2.4 GHz and 5 GHz bands, and thus includes any “wireless local area network (WLAN) products that are based on the Institute of Electrical and Electronics Engineers' (IEEE) 802.11 standards”. The smaller cell 148 may also be referred to as an access point cell. Typically access points such as access point 150 communicate with wireless terminals using unlicensed frequencies.

As shown in FIG. 3, telephony system 20 comprises roaming processor 160. Although phrased as a processor, roaming processor 160 may comprise one or more processors, controllers, or servers, either co-located or distributed, that facilitate roaming of telephony device 120 within the territory in which the service of internet-based telephony system 20 is available, e.g., available through co-operation of wireless access points. An example of such an Internet-based telephony system 20 is a voice over IP (VoIP) telephony system. However, in view of the fact that the communications encompassed by the technology described herein is not limited to voice communications, the internet-based telephony system 20 may also be referred to as a “Communication over IP”, or “CoIP system”.

It is understood by those skilled in the art that a telephony device may roam in various manners or scenarios. Three example scenarios are briefly discussed below. Further descriptions reside in U.S. patent application Ser. No. 14/291,566, filed May 30, 2014; and U.S. patent application Ser. No. 14/333,490, filed Jul. 16, 2014, both of which are incorporated herein by reference in their entireties.

In a first roaming scenario, a telephony device may roam from one access point cell to another access point cell. In such scenario, the telephony device 120 remains within WiFi or WiMax coverage, and is essentially handed off from one microcell to another microcell.

In a second roaming scenario, the telephony device may roam away from an access point so that it is no longer with in WiFi or WiMax coverage but still is able to make a data connection through the licensed frequencies of a macro base station over the air interface (e.g., through appropriate core network nodes such as Serving GPRS Support Node (SGSN)). In this second scenario telephony device 120 still has access through the data services of the macro cell to telephony system 20. An example of such a scenario (in which the telephony device 120 roams from access point coverage to macro base station coverage) is shown by telephony device 120′ (shown in broken lines in FIG. 3), since in FIG. 3 the base station 146 is a GPRS-capable base station.

In a third roaming scenario, the telephony device may roam away from either an access point (e.g., from a microcell) or a macro base station with data service (e.g., a GPRS macro base station) to a cellular base station that does not have data service. Upon handoff to a non-data cellular base station, the IP telephony system 20 will not be able to serve the telephony device and the telephony device must register with the non-data cellular operator or an existing call or connection is lost.

It may turn out, for example in either the first or second scenario described above, that the data connection may be of insufficient quality to support a data call. Or the user may anticipate that in the near future it will be difficult or impossible to support the data connection due to roaming (e.g., the user may anticipate roaming into a non-data cell as in the third roaming scenario described above). In such case, the user has an option of changing or replacing the Subscriber Identity Module (SIM) card for the telephony device so that a subsequent incoming call will be terminated over a cellular network rather than over the IP telephony system 20. The technology disclosed herein concerns how the telephony device and first IP telephony system may respond in the event of such a SIM card change or replacement, and as such concerns both structure and operation of the telephony device and the first IP telephony system to accommodate the SIM card change.

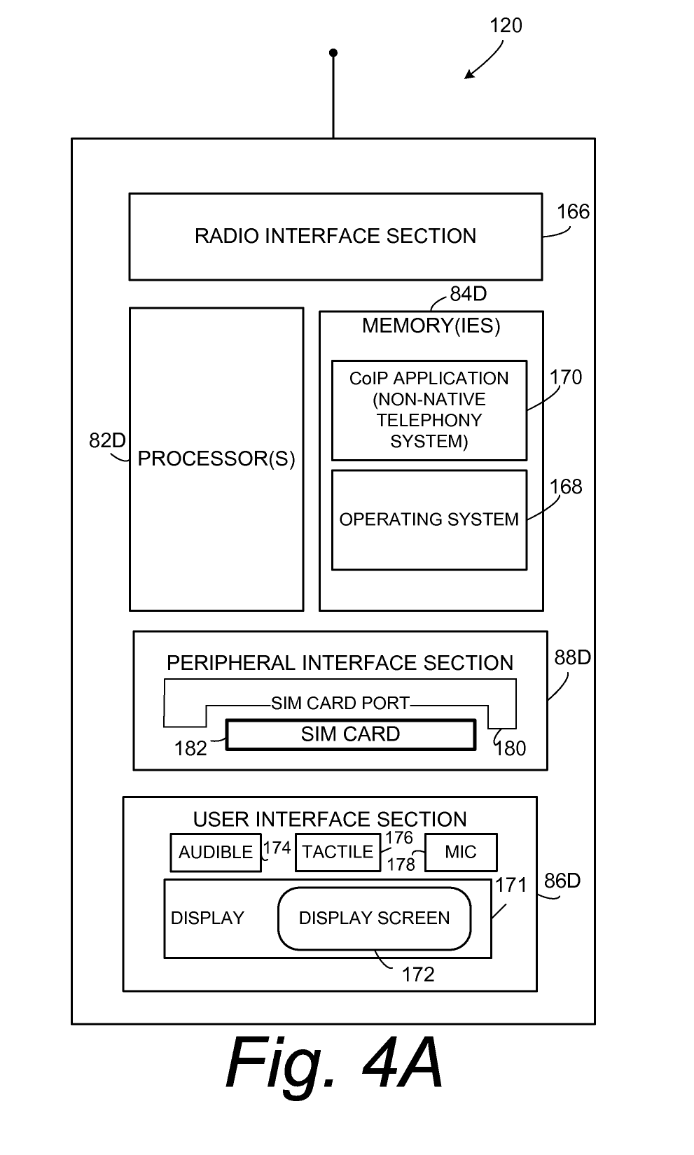

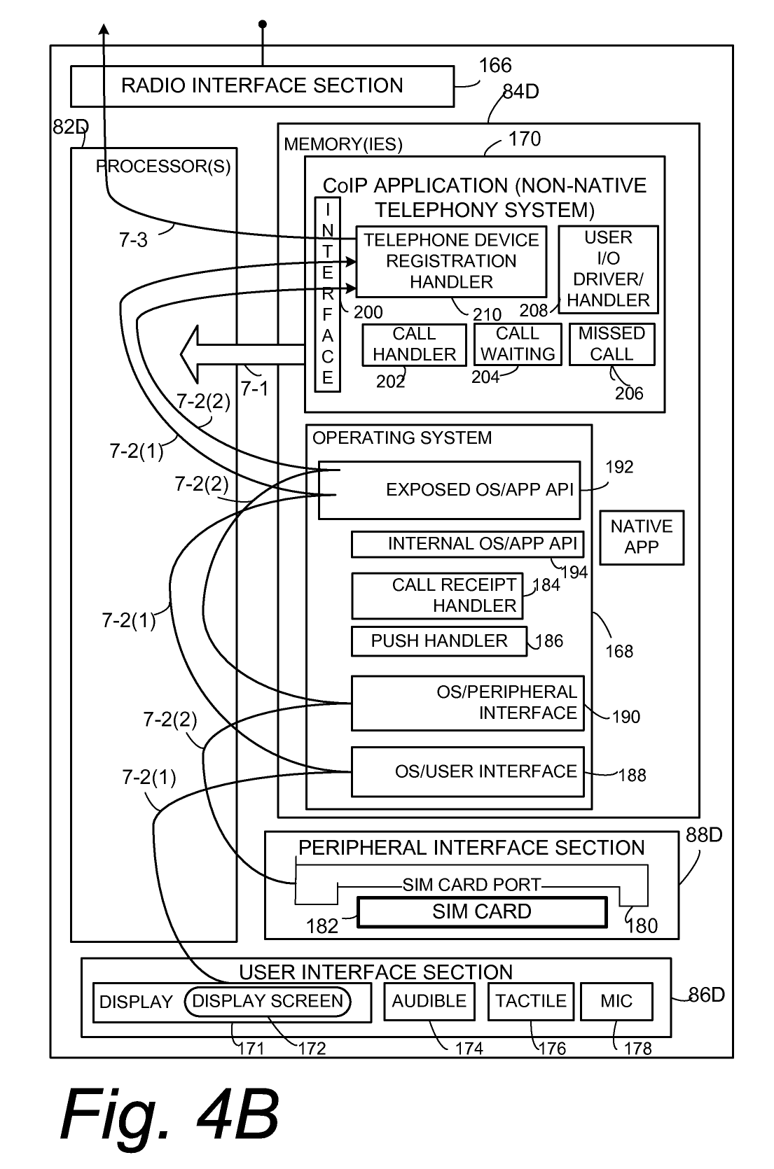

FIG. 4A shows general structural and functional components of telephony device 120 according to an example embodiment. The telephony device 120 of FIG. 4A includes radio interface section 166; user interface section 86D; peripheral interface section 88D; memory(ies) 84D; and processor(s) 82D.

Radio frequency section 166, also known as a radio frequency interface, is configured to enable telephony device 120 to communicate over radio frequencies, e.g., over an air or radio interface, with an appropriate communication node. As understood from FIG. 3, in some situations the communication node may be the wireless access point 150 through which the telephony device 120 participates in WiFi or WiMax type data communications, as a link in overall data communications with the IP telephony service 20. In other situations also understood from FIG. 3 the communication node may be a macro base station 146 through which the telephony device 120 participates in GPRS-type communications, as a link in overall data communications with the IP telephony service 20. A person skilled in the art will understand that radio frequency section 166 therefore includes appropriate transmitter(s) and receiver(s), as well as antenna(s), as well as radio frequency processing circuitry for pre-processing or post-processing of signals applied to or received from such transmitter(s) and receiver(s).

The memory(ies) 84D may comprise one or more different types of non-transient memories, including random access memory (RAM) and read only memory (ROM). As mentioned above, memory(ies) 84D may have stored therein instructions, in the form of programs or systems, which are executed by processor 82D. In other words, the programs or systems stored in memory(ies) 84D are, at appropriate times, loaded into instruction registers or the like of processor 82D and are executed by processor 82D. For example, telephony device operating system 168 is stored in memory(ies) 84D and executed by processor 82D. Another program stored in memory(ies) 84D and executed by processors 82D is CoIP application 170, described herein. The CoIP application 170 is an example of software 100 shown in FIG. 3.

The user interface 86D may comprise one or more different types of interface devices, and includes interface devices that are configured to facilitate interaction with a user. As shown in FIG. 4A, among the interface devices that may comprise user interface 86D are display/touch screen 171 (which comprises display screen 172), audible output device 174 (speaker), tactile output device (e.g., haptic device) 176, and microphone 178.

As used herein, “display screen” refers to a portion of a display device on which content may be displayed, e.g., to the actual area of a display device wherein pixels or driven illustration elements are located and are visible. A “screen display”, on the other hand, refers to content that is actually rendered on the display screen as a result of execution of instructions that generate the screen display.

The processor 82D may comprise one or more processor(s) or controller(s) as elaborated herein and discussed further with respect to FIG. 2. The processor 82D executes various sets of instructions stored on non-transient computer-readable media. These sets of instructions may be stored in memory(ies) 84D. One of the sets of instructions comprises operating system 168 for telephony device 120. Other of the sets of instructions may comprise software programs, at least some of which are in the form of computerized executable applications (“apps”).

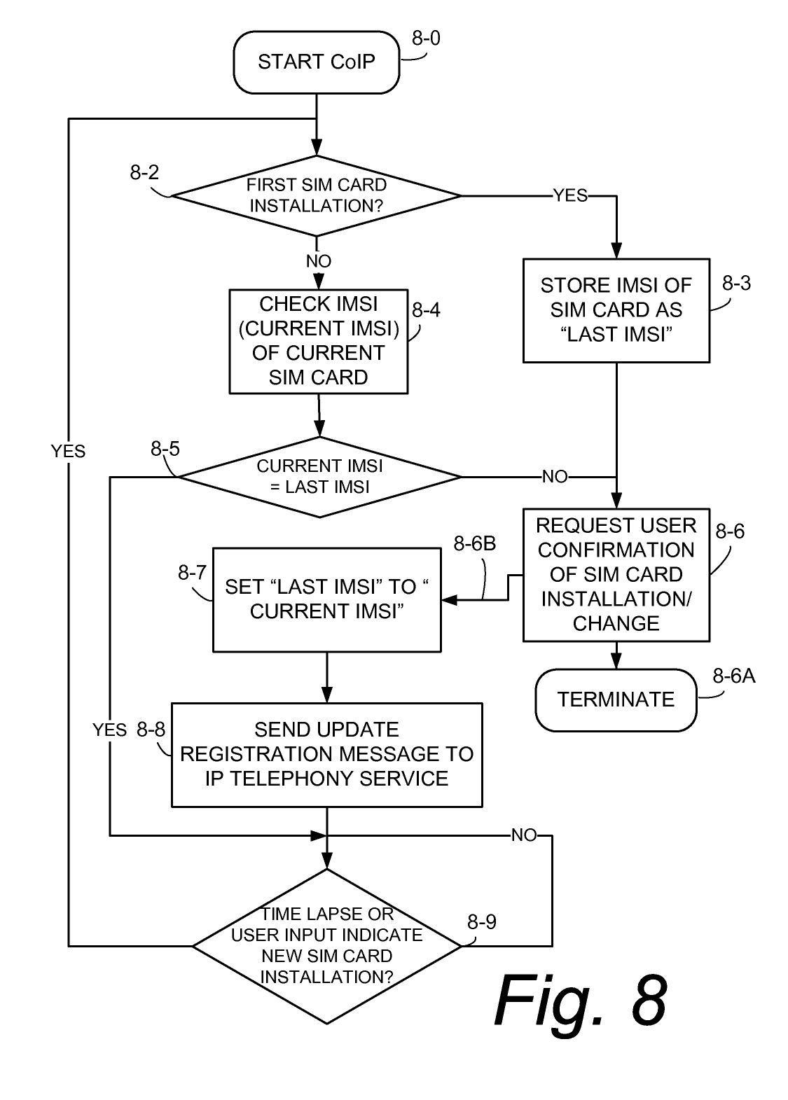

One such executable application may be an application provided by or designed to work in conjunction with communications sent or received by or routed through a telephony network, such as internet-based telephony system 20, and thus may generically be termed a “network application” installed on the telephony device. It was mentioned previously that the communications encompassed by the technology described herein are not limited to voice communications, and for that reason the internet-based telephony system 20 may also be referred to as a “Communication over IP”, or “CoIP system”. Accordingly, for the same reasons the network application executed by processor 82D of telephony device 120 may be referred to as the aforementioned “CoIP application” 170. As such, “CoIP” comprises but it not limited to VoIP communications. The CoIP application 170 may take the form of a computer software product (such as software 100 show in FIG. 2) comprising instructions stored on a non-transient memory which, when executed by processor 82D of telephony device 120, result in performance of the acts herein described (see, acts of FIG. 4B, FIG. 7, and FIG. 8).

A peripheral interface 88D of telephony device 120 comprises SIM card port 180. As shown in FIG. 4A the SIM card port 180 accommodates Subscriber Identity Module (SIM) card 182.

FIG. 4B shows in more detail an example, non-limiting implementation of the telephony device 120 of FIG. 4A. For example, FIG. 4B shows operating system (OS) 168 by way as comprising incoming call receipt handler 184, push handler 186, and several interfaces. The illustrated OS interfaces comprise OS/user interface 188 and OS/peripheral interface 190 as well as two application programmable interfaces (API) 192 and 194.

The API 192 is an “exposed” application programmable interface. In other words, exposed application programmable interface (API) 192 is an interface through which a third party executable application, e.g., an executable application (such as CoIP application 170) may interact with the operating system 168, and thus through operating system/user interface 188, to user interface 86D. Typically the executable application is non-native to operating system 168.

Operating system 168 also has one or more “internal” application programmable interfaces 194 through which only native executable applications may have access for interaction with the operating system 168. One such native executable application may be (for example) a native executable application for a native telephony service. Although operating system 168 comprises many other aspects, only those pertinent to the technology disclosed herein are specifically discussed herein.

FIG. 4B further shows CoIP application 170 as comprising interface 200 (which is an interface to operating system 168); call handler 202; call waiting handler 204; missed call handler 206; user input/output (I/O) driver/handler 208; and telephony device registration handler 210. It will be appreciated that the CoIP application 170 may comprise other functionalities and units not illustrated herein.

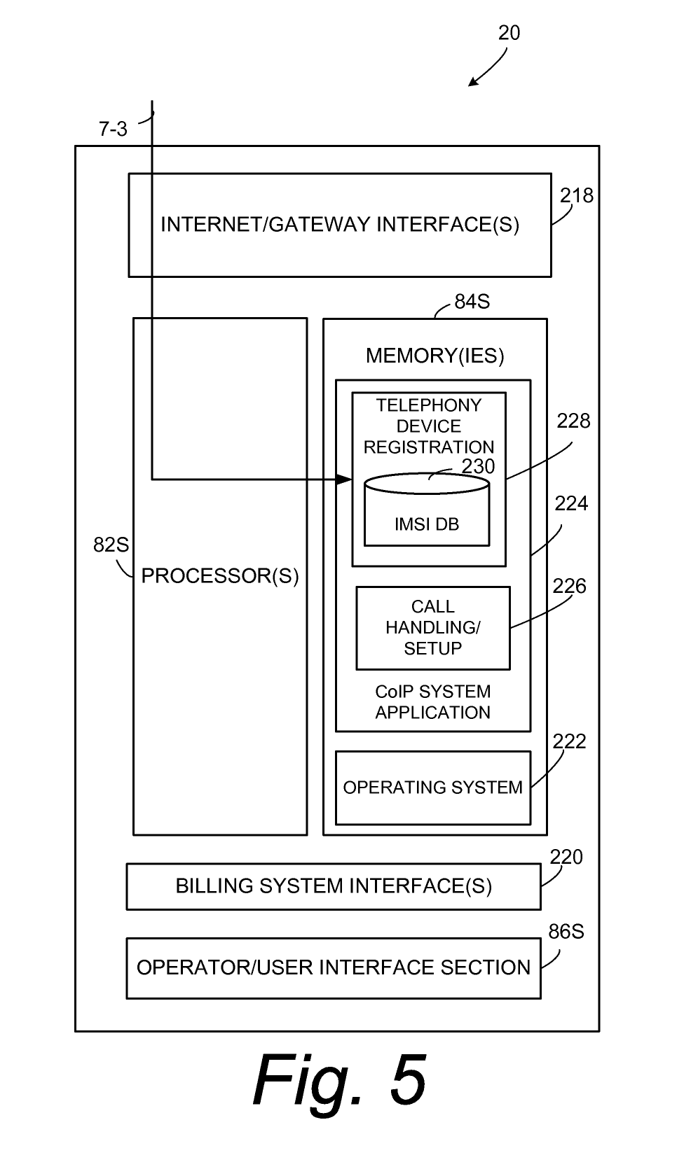

FIG. 5 shows selected basic aspects of IP telephony system 20 according to an example embodiment. Among the illustrated functionalities and units of IP telephony system 20 are processor(s) 82S, memory(ies) 84S, operator/user input/output interfaces 86S, internet/gateway interface(s) 218, and other interfaces 220 (such as billing system interfaces). As understood from FIG. 2 and the preceding discussion of the telephony device, the processors 82S of IP telephony system 20 executes coded instructions, including IP telephony system operating system 222 and CoIP System application 224. Among the functions provided upon execution of CoIP System application 224 are call setup (depicted by call setup unit 226) and telephony device registration (depicted by telephony device registration unit 228). In executing CoIP System application 224, the processors 82S performs the function of roaming processor 160 for IP telephony system 20, among its other functions.

As mentioned above in conjunction with FIG. 3, a telephony device may roam to such an extent that the data connection may be of insufficient quality to support a data call, or the user may anticipate that it will be difficult or impossible to support the data connection due to roaming. For example, in the situation shown in FIG. 3 the telephony device may roam to its broken line position 120′ and there determine that the data connection is of insufficient quality. The broken line position 120′ may be, for example, in the jurisdiction of the second country shown in FIG. 1.

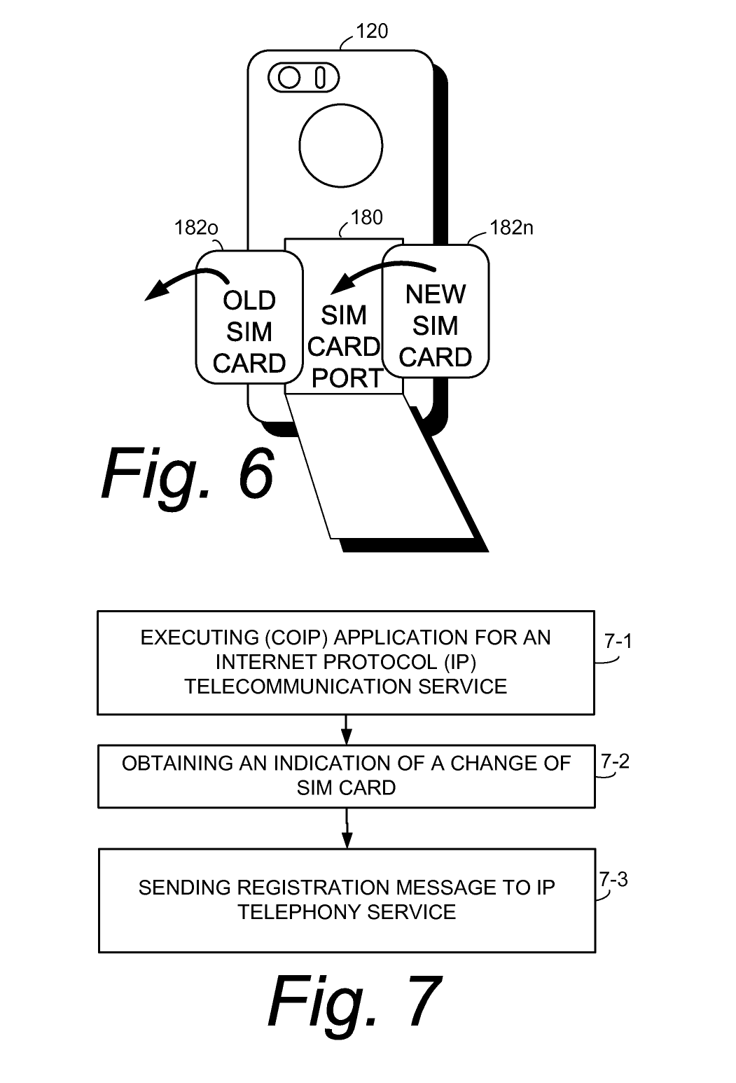

As further mentioned above, upon experiencing insufficient quality to support a data connection or fearing loss of data connection, the user has an option of changing or replacing the Subscriber Identity Module (SIM) card for the telephony device. FIG. 6 shows an old SIM card 182o, which may also be referred to as the “previous”, “initial”, or “original” SIM card, being taken out of SIM card port 180 and replaced with new or “replacement” SIM card 182n. A purpose in replacing old SIM card 182o with new SIM card 182n is so that a subsequent incoming call will be terminated over a cellular network to a called party number associated with the IMSI included in the registration message. As mentioned above, the technology disclosed herein concerns, e.g., how the telephony device and IP telephony system may respond in the event of such a SIM card change or replacement.

FIG. 7 shows example, representative, non-limiting basic acts or steps that may be executed by telephony device 120 according to an example embodiment and mode of the technology disclosed herein. Act 7-1 comprises the processors 82D of telephony device 120 executing a Communications over Internet Protocol (CoIP) application (e.g., CoIP application 170) for an Internet Protocol (IP) telecommunication service (e.g., IP telephony system 20). Act 7-1 is also reflected by arrow 7-1 in FIG. 4B, which depicts loading, or calling from background into foreground, of CoIP application 170 into CPU of processors 82D.

Act 7-2 comprises obtaining an indication of a change of a Subscriber Identity Module (SIM) card of the mobile telephony device. The act of the change of Subscriber Identity Module (SIM) card, e.g., from SIM card 182o to SIM card 182n, is illustrated by way of example in FIG. 6. An indication of such change of SIM card may be obtained in several ways.

A first example way of obtaining the indication of the change of the Subscriber Identity Module (SIM) card of the mobile telephony device comprises receiving an indication of the change of the Subscriber Identity Module (SIM) card from a user through a user interface of the telephony device, e.g., through input/output interfaces 86D. For example, the user may manipulate and/or respond to one or more screen displays, generated by user input/output (I/O) driver/handler 208, to inform the telephony device registration handler 210 that the user has changed or will change out the SIM card, e.g., replace old SIM card 182o with new SIM card 182n. Reception of such a user-interface initiated notification of change of the Subscriber Identity Module (SIM) card is depicted by arrow 7-2(1) in FIG. 4B. The input indication from input/output interface 86D is handled by OS/user interface 188, which then supplies the input indication through exposed API 192 to the telephony device registration handler 210 of CoIP application 170.

A second example way of obtaining the indication of the change of the Subscriber Identity Module (SIM) card of the mobile telephony device comprises the telephony device 120 automatically detecting the change of the Subscriber Identity Module (SIM). For example, upon detecting the removal of old SIM card 182o and insertion of new SIM card 182n in SIM card port 180, the SIM card port 180 generates a signal which notifies the telephony device operating system 168 that SIM card replacement has occurred. Upon reception of a signal from SIM card port 180, telephony device operating system 168 generates a signal which is sent through exposed API 192 to telephony device registration handler 210 of CoIP application 170. The signals of this second example way of obtaining the indication of the change of the SIM card are depicted by arrow 7-2(2) in FIG. 4B.

Act 7-3 comprises the processor 82D, as it executes the CoIP application 170 after receiving the indication of act 7-2, sending a registration message to the IP telecommunication service. The registration message, depicted by arrow 7-3 in FIG. 4B, is generated by telephony device registration handler 210 and sent through interface 200 to radio interface section 166. As understood from preceding discussion, when in coverage of an access point 150, the registration message is sent through a WiFi or WiMax data connection to IP telephony system 20. Alternatively, the registration message of act 7-3 may be sent through GPRS-type data connection of a cellular network, e.g., through GPRS-type base stations 146.

In an example embodiment, the registration message of act 7-3 includes both a new International Mobile Subscriber Identity (IMSI) for the mobile telephony device and an account identifier (e.g., customer account of the user of telephony device 120 from the perspective of the IP telephony system 20), or other identifier for telephony device 120 which is allocated by or recognizable by IP telephony system 20. As is well known, the International Mobile Subscriber Identity (IMSI) is usually presented or expressed as a 15 digit long number. The first 3 digits of the IMSI are the mobile country code (MCC), which are followed by the mobile network code (MNC), either 2 digits or 3 digits (depending on the MCC and operator). The remaining digits are the mobile subscription identification number (MSIN) within the network's customer base.

FIG. 8 shows example, representative acts or steps that may be performed by telephony device registration handler 210 of CoIP application 170 according to an example embodiment and mode. In other words, FIG. 8 shows representative acts or steps that may be performed by processors 82D when executing CoIP application 170, including the telephony device registration handler 210 aspect of CoIP application 170. The acts of FIG. 8 may be referred to and comprise a SIM card registration procedure.

Act 8-1 comprises determining whether execution of the CoIP application 170 has begun. “Beginning” or “starting” of CoIP application 170 may either be initial loading of CoIP application 170 into processor 82D, or loading of CoIP application 170 from background into foreground execution.

Act 8-2 comprises determining whether the CoIP application 170 is being notified of an initial or first installation of a SIM card for telephony device 120. If the CoIP application 170 determines that it has not previously been provided with an International Mobile Subscriber Identity (IMSI) for a SIM card, CoIP application 170 recognizes that an initial SIM card registration is occurring and executes act 8-3. Act 8-3 comprises telephony device registration handler 210 of CoIP application 170 storing the International Mobile Subscriber Identity (IMSI) of the SIM card found in its SIM card port 180 as a “LAST IMSI”. Thus, in terms of a subsequent or update registration message, the registration message processed by act 8-3 may be referred to as a previous registration message which included a previous International Mobile Subscriber Identity (IMSI) for the mobile telephony device to the Internet Protocol (IP) telecommunication service.

If the CoIP application 170 determines as act 8-2 that a SIM card other than an initial SIM card is being loaded into telephony device 120, act 8-4 is performed. Act 8-4 comprises the telephony device 120 determining the IMSI of the current SIM card loaded into SIM card port 180. In this regard, telephony device registration handler 210 sends a request through interface 200 and exposed API 192 to OS/peripheral interface 190 so that OS/peripheral interface 190 will obtain a “CURRENT IMSI” value of the SIM card currently loaded into SIM card port 180. The “CURRENT IMSI” value is then sent back through exposed API 192 and interface 200 to telephony device registration handler 210. The telephony device registration handler 210 then determines, as act 8-5, whether the just-obtained “CURRENT IMSI” value is the same as the “LAST IMSI”.

If it is determined as act 8-5 that the just-obtained “CURRENT IMSI” value is not the same as the “LAST IMSI”, act 8-6 may optionally be performed. Act 8-6 may also optionally be performed after act 8-3. Act 8-6 comprises the telephony device registration handler 210 through user input/output (I/O) driver/handler 208 requesting that the user confirm by appropriate response on input/output interface 86D that a SIM card has been loaded into SIM card port 180. If a confirmation is requested and not received, the telephony device registration handler 210 has the options of either terminating with the SIM card registration procedure of FIG. 8 (as indicated by act 8-6A) or continuing with the SIM card registration procedure of FIG. 8 (as indicated by arrow 8-8B).

Act 8-7 comprises setting the “LAST IMSI” equal to the just-obtained “CURRENT IMSI” value. In this way the appropriate IMSI value will be used for the next execution of act 8-4.

Act 8-8 comprises the telephony device registration handler 210 sending the registration message of act 7-3 to IP telephony system 20. The registration message of act 8-8 may be referred to as a “new” or “update” registration message which includes the new IMSI of the new SIM card 182n. As indicated above, in an example implementation the update registration message of act 7-3 includes the new IMSI, e.g., the newly detected “CURRENT IMSI”, and an indication of the account identifier of the telephony device 120 with respect to IP telephony system 20, or other appropriate identifier. The sending of update registration message of act 7-3 to IP telephony system may occur when the telephony device is within a data network, e.g., has WiFi or WiMax access, so that the registration message can be sent to IP telephony system 20.

Act 8-9 either follows act 8-8 or a positive determination that “CURRENT IMSI”=“LAST IMSI” at act 8-6. Act 8-9 comprises the telephony device registration handler 210 determining whether a sufficient time lapse or delay has occurred before the SIM card registration procedure of FIG. 8 should again be executed, or alternatively whether the user has indicated via input/output interface 86D that the user has or intends to replace the existing SIM card. Should either the time delay lapse or such user indication be detected, processing continues or loops back to act 8-2. Otherwise, a pause occurs in execution of CoIP application 170 until either of the conditions of act 8-9 are satisfied.

FIG. 9 shows example, representative acts or steps that may be performed by an IP telephony system such as IP telephony system 20 according to an example embodiment and mode. Act 9-1 comprises the IP telephony system 20 receiving a registration message from a mobile telephony device. As mentioned above, in an example embodiment and mode the registration message includes at least a portion of an International Mobile Subscriber Identity (IMSI) and account identifier allocated or accorded by the Internet Protocol (IP) telecommunication service to the telephony device.

Act 9-2 comprises the CoIP System application 224 of the IP telephony system 20 making a determination that the IMSI included in the registration message indicates a change in IMSI for the mobile telephony device If it is determined that the IMSI included in the registration message does indicate a change in IMSI, act 9-3 is performed. Act 9-3 comprises the IP telephony system 20 forwarding an incoming call to the telephony device 120, e.g., an incoming call for the account identifier associated with telephony device 120, to a calling number obtained by the IP telephony system 20 so that the incoming call is terminated over a cellular network. The incoming call is thus terminated using a calling number rather than at an IP address. Thus, act 9-3 is performed based on the determination of act 9-2. In differing example embodiments and modes, the calling number may be obtained either from the home network associated with the IMSI included in the registration message, from the IP telephony system 20, or from the mobile telephony device.

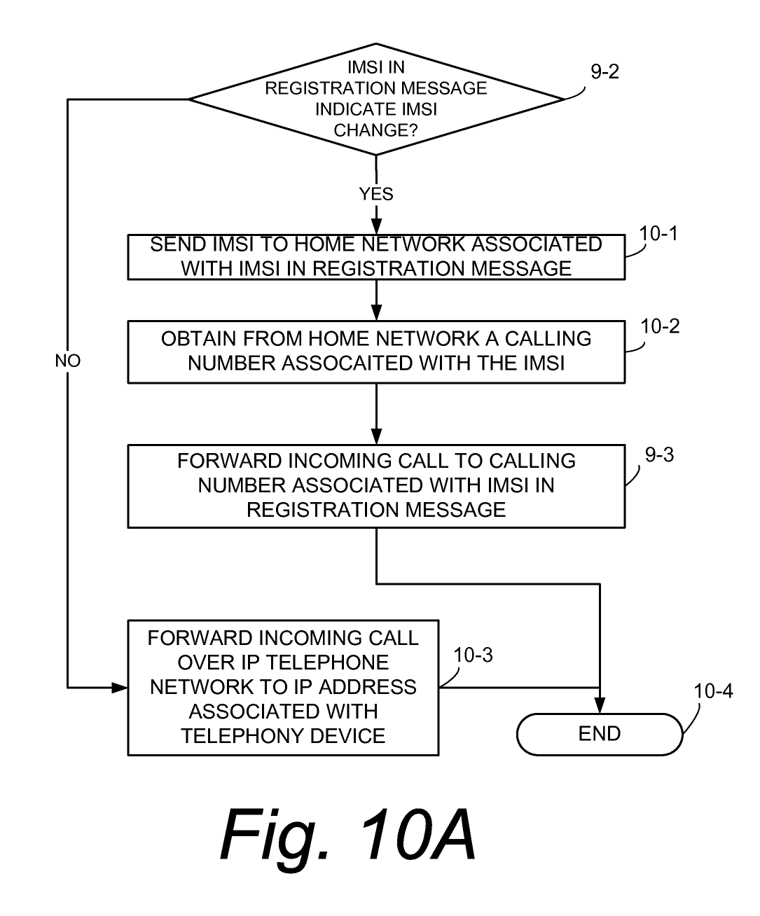

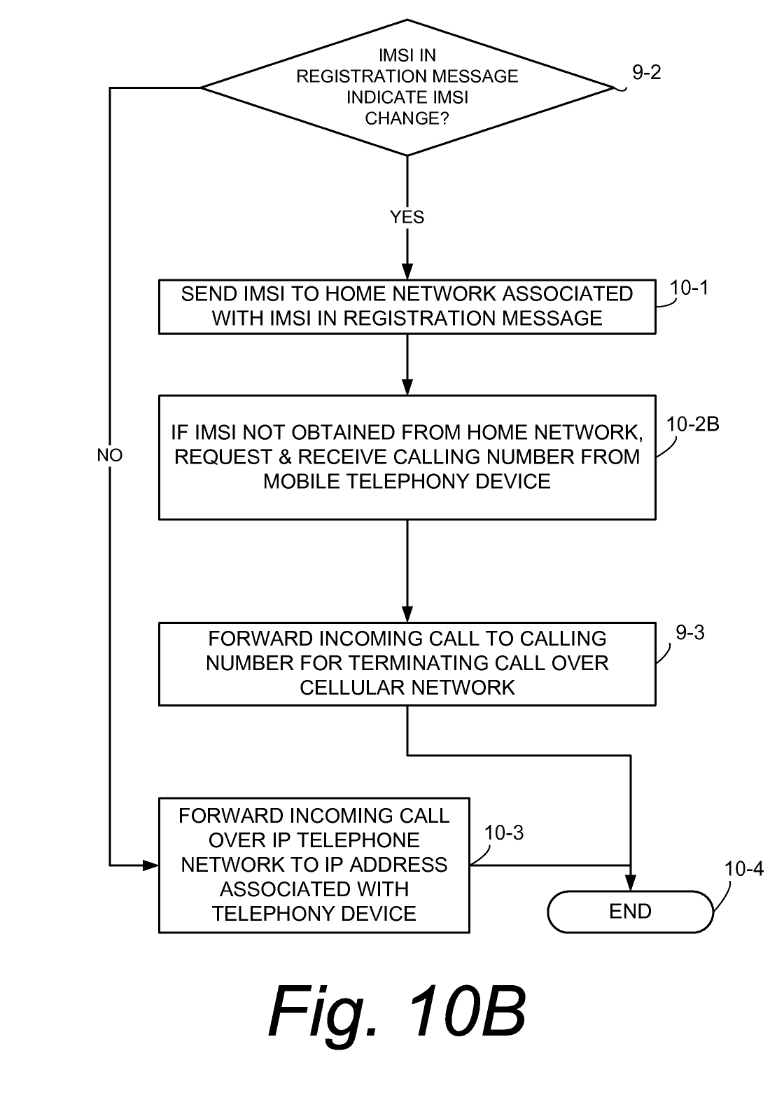

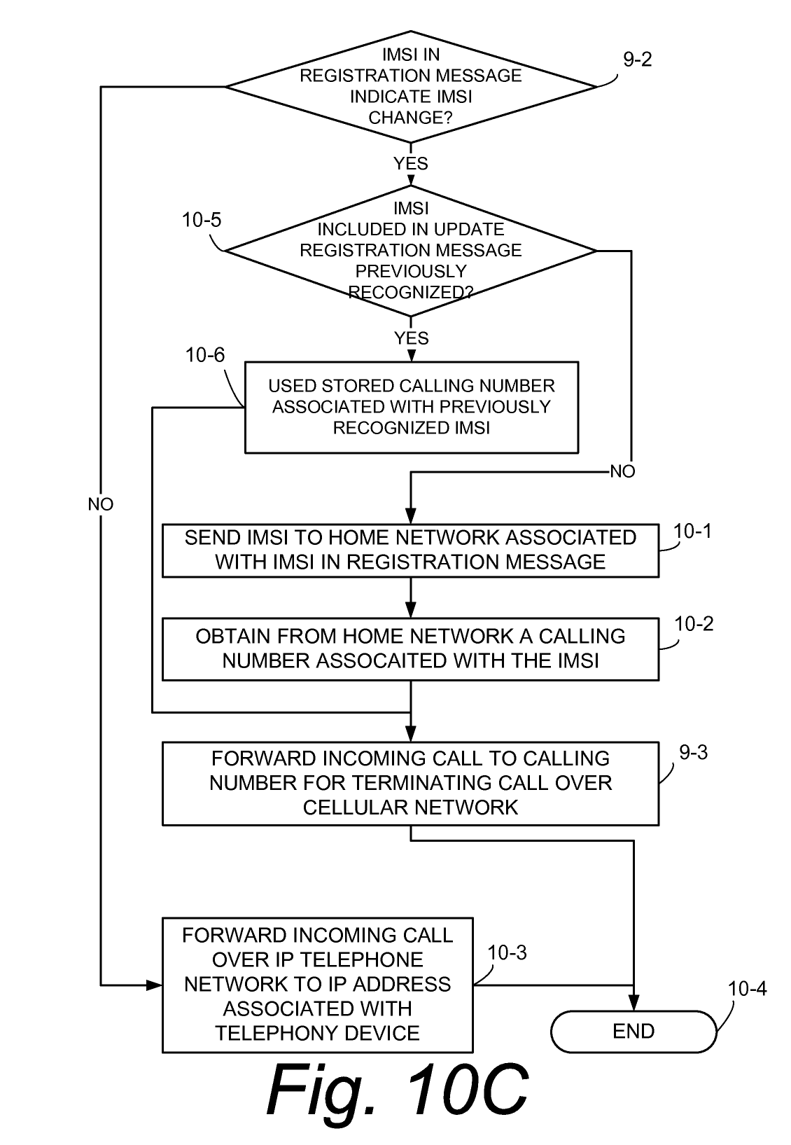

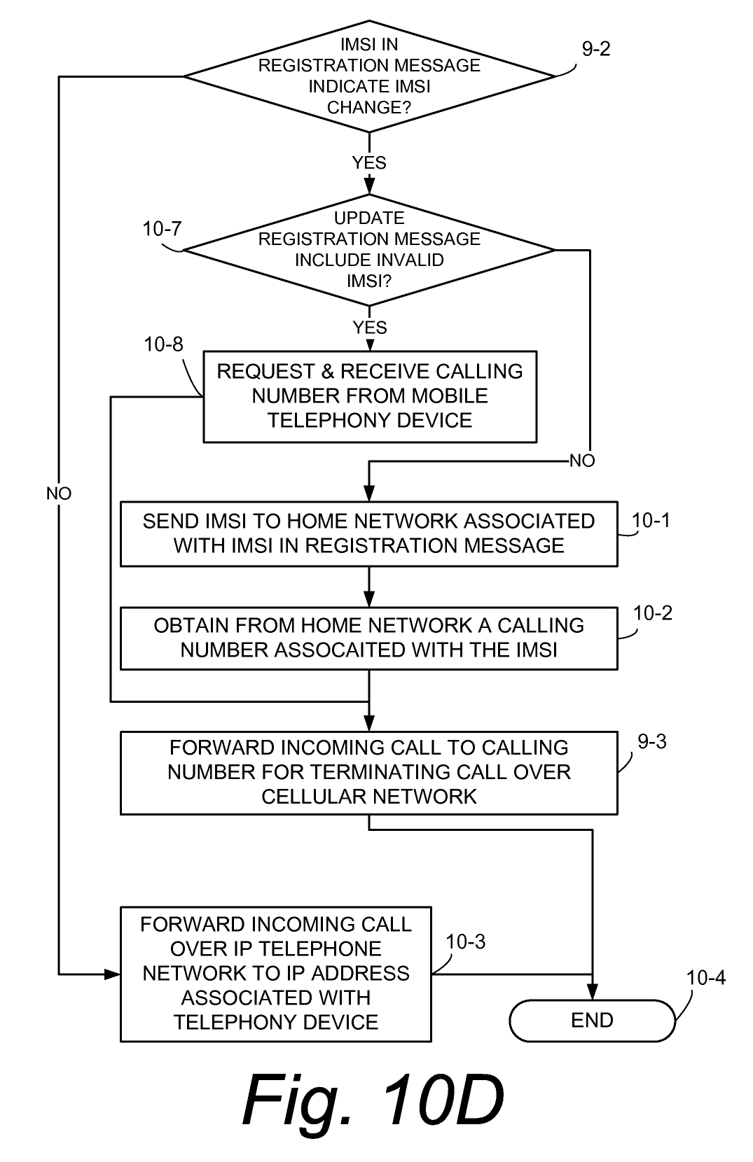

FIG. 10A shows in further detail a SIM card registration acknowledgment procedure that may be performed by CoIP System application 224 of the IP telephony system 20 of FIG. 5 according to a first example embodiment and mode. Act 9-2 of FIG. 10 comprises making a determination that the IMSI included in the registration message indicates a change in IMSI for the mobile telephony device. Act 9-2 may comprise, for example, the CoIP system application 224 making a determination that the IMSI included the registration message is different than the most recent IMSI stored in the CoIP system application 224 for the telephony device.

If it was determined at act 9-2 that the IMSI value received in the registration message indicates a change of IMSI, act 10-2 and act 10-3 are performed before performance of act 9-3. Act 10-1 comprises the IP telephony system 20 sending the IMSI included in the registration message to a home network associated with the IMSI included in the registration message, and requesting a calling party number for the telephony device 120. As mentioned above, the International Mobile Subscriber Identity (IMSI) comprises the mobile country code (MCC), the mobile network code (MNC), and the mobile subscription identification number (MSIN). Thus, from the IMSI the IP telephony system 20 knows the mobile network code and thus can obtain information for sending the IMSI to the home network associated with the IMSI included in the registration message.

Act 10-2 comprises obtaining from the home network associated with the IMSI included in the registration message, in response to the message sent as act 10-1, a calling number associated with the IMSI (obtaining, e.g., the Mobile Station International Subscriber Directory Number [MSISDN]). The MSISDN obtained as act 10-2 is stored in an IMSI database 230 in association with the account identifier for the telephony device.

Assuming that the home network associated with the IMSI included in the registration message is able to provide the MSISDN, should an incoming call subsequently be received by IP telephony system 20 for the account identifier associated with telephony device 120, as act 9-3 the IP telephony system 20 forwards the incoming call for the account identifier to the calling number (MSISDN) so that the incoming call is terminated over a cellular network rather than to an IP address associated with the account for the telephony device 120.

If the IMSI received in the registration message were determined at act 9-2 to be unchanged (e.g., unchanged from the previous IMSI for the telephony device), as act 10-3 the IP telephony system 20 knows to forward the next incoming call over IP telephony system 20 to the IP address associated with the telephony device.

After execution of either act 9-3 or act 10-3, the SIM card registration acknowledgment procedure of FIG. 10A terminates as indicated by act 10-4.

The SIM card registration acknowledgment procedure of FIG. 10B resembles the SIM card registration acknowledgment procedure of FIG. 10A but includes act 10-2B rather than act 10-2. Act 10-2B is performed if, after the IMSI received in the registration message is sent to the home network associated with the IMSI included in the registration message (act 9-2), the home network associated with the IMSI included in the registration message is unable to provide a calling number, e.g., the home network is unable to provide a MSISDN. Act 10-2B comprises the IP telephony system 20 sending a message to the CoIP application 170 of the telephony device, and particularly a message that results in an output prompt to the user so that the user will enter the MSISDN in an appropriate user interface input device of user interface section 88D. The user-input MSISDN may then be stored by CoIP System application 224 of the IP telephony system 20 in association with the IMSI and/or account identifier in IMSI database 230. Then, when an incoming call is subsequently received by IP telephony system 20 for the account identifier associated with telephony device 120, as act 9-3 the IP telephony system 20 forwards the incoming call for the account identifier to the calling number (MSISDN) so that the incoming call is terminated over a cellular network rather than to an IP address associated with the account for the telephony device 120.

The SIM card registration acknowledgment procedure of FIG. 10C resembles the SIM card registration acknowledgment procedure of FIG. 10A but further includes act 10-5 and act 10-6. Act 10-5 may be executed when it is determined at act 9-2 that the IMSI included in the registration message indicates a change in IMSI for the telephony device. Act 10-5 comprises determining if the IMSI included in the registration message is recognized as an IMSI which has previously been associated with the telephony device or customer identifier. If it is determined as act 10-5 that the IMSI included in the registration message is recognized an IMSI has previously been associated with the telephony device or customer identifier, then the CoIP System application 224 of the IP telephony system 20 knows that it has likely already obtained a calling number for the previously recognized IMSI and has stored the already-obtained calling number in association with the previously recognized IMSI in IMSI database 230. IMSI database 230 may comprise memory(ies) 84S and may store therein the IMSI originally associated by the IP telephony system 20 with the telephony device 120, or an IMSI which the IP telephony system 20 is otherwise authorized to serve for telephony device 120 and for which an associated calling number is already known. In this regard, the telephony device registration unit 228 of CoIP System application 224 may in IMSI database 230 keep a record of IMSI values of telephony device 120 which IP telephony system 20 is authorized to serve, along with the associated calling number and/or account identifier.

If the IMSI included in the registration message is recognized an IMSI has previously been associated with the telephony device, then as act 10-6 the SIM card registration acknowledgment procedure of FIG. 10C performed by CoIP System application 224 of the IP telephony system 20 obtains the stored calling number associated with the previously recognized IMSI. Then, when an incoming call is received by IP telephony system 20 for the telephony device, as act 9-3 IP telephony system 20 forwards the incoming call to the calling number for termination of the incoming call over a cellular network. Thus, in the SIM card registration acknowledgment procedure of FIG. 10C the recognition of the previously used IMSI for the telephony device may conveniently eliminate again consulting the home network associated with the IMSI included in the registration message to determine the calling number.

The SIM card registration acknowledgment procedure described above may be performed when a telephony device experiences SIM card replacement more than once. For example, if it were to happen that a user where to replace the original SIM card with a replacement SIM card having an IMSI that is different than the original SIM card, act 10-1 through act 10-2 would be performed. Then if the user were subsequently to remove the replacement SIM card and return the original SIM card, the SIM card registration acknowledgment procedure would again be performed. If the SIM card registration acknowledgment procedure is that of FIG. 10A, then act 10-1 through act 10-2 would be performed for the original SIM card. If the SIM card registration acknowledgment procedure is that of FIG. 10C, as act 10-5 the original SIM card would be recognized as a previously used SIM card for the telephony device, and the CoIP System application 224 of the IP telephony system 20 would (as act 10-6) obtain the calling number previously stored in IMSI database 230 in association with the original IMSI.

The SIM card registration acknowledgment procedure of FIG. 10D resembles the SIM card registration acknowledgment procedure of FIG. 10A but further includes act 10-7 and act 10-8. Act 10-7 comprises making a determination, e.g., a validity determination, that the IMSI included in the registration message is valid. One example reason that the registration message may fail to include a valid IMSI is that the information included in the registration message may not constitute a full or valid IMSI. For example, the operating systems of some telephony devices may not be able to recognize or ascertain an entire IMSI for a SIM card. While most telephony devices can recognize or detect the Mobile Country Code (MCC) and Mobile Network Code (MNC), not all telephony devices can detect the Mobile Subscriber Identification Number (MSIN).

If IMSI included in the registration message is determined to be valid, act 10-1 is performed as above described. But if the IMSI included in the registration message is determined to be invalid, act 10-8 is performed. Act 10-8 comprises the CoIP System application 224 of the IP telephony system 20 requests a calling number (e.g., the MSISDN) from the telephony device 20. That is, act 10-8 comprises sending a message to the CoIP application 170 of the telephony device, and particularly a message that results in an output prompt to the user so that the user will enter the MSISDN in an appropriate user interface input device of user interface section 88D. Then, upon obtaining the MSISDN and storing the MSISDN in association with the account identifier, when an incoming call is subsequently received by IP telephony system 20 for the account identifier associated with telephony device 120, as act 10-4 the IP telephony system 20 forwards the incoming call for the account identifier to the calling number (MSISDN) so that the incoming call is terminated over a cellular network rather than to an IP address associated with the account for the telephony device 120.

Acts of any one of the SIM card registration acknowledgment procedures of FIG. 10A, FIG. 10B, FIG. 10C, and FIG. 10D may be combined with acts of the SIM card registration acknowledgment procedure of other embodiments. For example, the validation check acts 10-7 and 10-8 of the FIG. 10D embodiment may be combined with those of the SIM card registration acknowledgment procedures of FIG. 10A, FIG. 10B, and/or FIG. 10C.

An example of use of the technology disclosed herein occurs when a user of the telephony device travels from a first country to a second country. In the first county the telephony device may operate with a SIM card of a first country network carrier. When within coverage of a WiFi or WiMax network, either before arriving or after arrival in a second country, the user of the telephony device may change or replace the SIM card of the first country network with a SIM card of a second country network, in the manner illustrated for example in FIG. 6. After replacement of the SIM card and performance of the SIM card registration acknowledgment procedure as herein described, the IP telephony system 20 knows how to route an incoming call to the telephony device, e.g., to a calling number obtained from a home network for the second country carrier (e.g., the home network associated with the IMSI included in the registration message).

Thus, using the registration message of the technology disclosed herein, when the IP telephony system 20 receives an incoming call directed to the account ID, the IP telephony system 20 can terminate the call—ideally, locally—to the MSISDN mapped to the account ID. The incoming call can be, for example, a forwarded call as described in U.S. Pat. No. 8,600,364, or a call received for a roaming subscriber as described in U.S. patent application Ser. No. 14/291,566, filed May 30, 2014 and U.S. patent application Ser. No. 14/333,490, filed Jul. 16, 2014, all of which are incorporated herein by reference in their entireties.

Various functions described herein, including functions of roaming processor 82S of internet-based telephony system 20 and IP telephony application 170 (including telephony device registration handler 210) of telephony device 120, may, at least in some embodiments and modes, be performed by machine hardware such as that shown in FIG. 2. Software routines such as software for roaming of telephony system and the software (e.g., IP telephony application 170) for the telephony device 120 are executed by processor(s) 82S of the internet-based telephony system 20 and processor(s) 82D of telephony device 120, respectively. For the machine hardware of each processor such software may be stored on non-transient memory such as program instruction memory. Also, the software routines could also be stored remotely from the CPU, e.g., remotely from processors 82. For example, the software could be resident on servers and memory devices that are located remotely from the CPU, but which are accessible to the CPU via a data network connection.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A method of operating a mobile telephony device comprising:
executing, on a processor of the mobile telephony device, a Communications over Internet Protocol (CoIP) application for an Internet Protocol (IP) telecommunication service which is not native to the mobile telephony device;
obtaining an indication of a change of a Subscriber Identity Module (SIM) card of the mobile telephony device, wherein the change of the SIM card comprises a change from a first SIM card associated with a first network to a second SIM car associated with a second network; and upon obtaining the indication of the change,
sending an update registration message to the IP telecommunication service, the update registration message including a new International Mobile Subscriber Identity (IMSI) for the mobile telephony device.

2. The method of claim 1, further comprising, prior to obtaining the indication of the change of the Subscriber Identity Module (SIM) card, sending a previous registration message including a previous International Mobile Subscriber Identity (IMSI) for the mobile telephony device to the Internet Protocol (IP) telecommunication service.

3. The method of claim 1, wherein obtaining the indication of the change of the Subscriber Identity Module (SIM) card of the mobile telephony device comprises receiving an indication of the change of the Subscriber Identity Module (SIM) card from a user through a user interface of the telephony device.

4. The method of claim 1, wherein obtaining the indication of the change of the Subscriber Identity Module (SIM) card of the mobile telephony device comprises the telephony device automatically detecting the change of the Subscriber Identity Module (SIM).

5. The method of claim 1, further comprising obtaining the indication of the change of the Subscriber Identity Module (SIM) card when the Communications over Internet Protocol (CoIP) application is opened.

6. The method of claim 1, further comprising including in the registration message an account identifier allocated by the Internet Protocol (IP) telecommunication service.

7. A mobile telephony device comprising:
a radio communications interface;
a processor configured to:
execute a Communications over Internet Protocol (CoIP) application for an Internet Protocol (IP) telecommunication service;
obtain an indication of a change of a Subscriber Identity Module (SIM) card of the mobile telephony device, the change of the SIM card comprising a charge from a first SIM card associated with a first network to a second SIM card associated with a second network; and upon obtaining the indication of change,
generate, for sending over the radio communications interface, a registration message to the IP telecommunication service, the registration message including a new International Mobile Subscriber Identity (IMSI) for the mobile telephony device.

8. The mobile telephony device of claim 7, wherein the processor is further configured to send, prior to obtaining the indication of the change of the Subscriber Identity Module (SIM) card, a previous registration message including a previous International Mobile Subscriber Identity (IMSI) for the mobile telephony device to the Internet Protocol (IP) telecommunication service.

9. The mobile telephony device of claim 7, further comprising a user interface, and wherein the processor is configured to obtain the indication of the change of the Subscriber Identity Module (SIM) card of the mobile telephony device by receiving an indication of the change of the Subscriber Identity Module (SIM) card from a user through the user interface.

10. The mobile telephony device of claim 7, wherein the processor is configured to obtain the indication of the change of the Subscriber Identity Module (SIM) card of the mobile telephony device by automatically detecting the change of the Subscriber Identity Module (SIM).

11. The mobile telephony device of claim 7, wherein the processor is configured to obtain the indication of the change of the Subscriber Identity Module (SIM) card when the Communications over Internet Protocol (CoIP) application is opened.

12. The mobile telephony device of claim 7, wherein the processor is configured to include in the registration message an account identifier allocated by the Internet Protocol (IP) telecommunication service.

13. A method of operating an internet-based telephony system comprising:
receiving a registration message from a mobile telephony device, the registration number including an International Mobile Subscriber Identity (IMSI) and account identifier allocated by the Internet Protocol (IP) telecommunication service to the telephony device;
making a determination that the IMSI included in the registration message indicates a change in IMSI for the mobile telephony device from a first IMSI associated with a first network to a second IMSI associated with a second network; and,
based on the determination, forwarding an incoming call for the account identifier to a calling number of the second network associated with the IMSI included in the registration message.

14. The method of claim 13, further comprising:
sending the IMSI included in the registration message to a home network associated with the IMSI included in the registration message obtaining the calling number associated with the IMSI from the home network associated with the IMSI included in the registration message; and thereafter
forwarding the incoming call for the account identifier to the calling number so that the incoming call is terminated over a cellular network.

15. The method of claim 13, further comprising:
making a previous recognition determination that the internet-based telephony system has previously associated the IMSI included in the registration message with a stored calling number associated with the IMSI; and
based on the previous recognition determination using the stored calling number as the calling number.

16. The method of claim 13, further comprising:
sending the IMSI included in the registration message to a home network associated with the IMSI included in the registration message for the mobile telephony device;
receiving an indication that the home network associated with the IMSI included in the registration message is not able to provide the calling number associated with the IMSI; and in accordance with the indication,
sending a message to the mobile telephony device to request the calling number for forwarding the incoming call.

17. The method of claim 13, further comprising:
making an invalidity determination that the registration message does not include a valid IMSI; and
based on the invalidity determination sending a message to the mobile telephony device to request the calling number for forwarding the incoming call.

18. A method of operating an internet-based telephony system comprising:
receiving a registration message from a mobile telephony device, the registration number including an International Mobile Subscriber Identity (IMSI) and account identifier allocated by the Internet Protocol (IP) telecommunication service to the telephony device;
making a determination that the IMSI included in the registration message is invalid; and,
based on the determination, sending a message to the mobile telephony device to request a calling number for forwarding an incoming call.

19. An internet-based telephony system comprising a processor configured to:
receive a registration message from a mobile telephony device, the registration number including at least a portion of an International Mobile Subscriber Identity (IMSI) and account identifier allocated by the Internet Protocol (IP) telecommunication service to the telephony device;
make a determination that the IMSI included in the registration message indicates a change in IMSI for the mobile telephony device from a first IMSI associated with a first network to a second IMSI associated with a second network; and,
based on the determination, forward an incoming call for the account identifier to a calling number of the second network associated with the IMSI included in the registration message.

20. The system of claim 19, wherein the processor is further configured to:
send the IMSI included in the registration message to a home network associated with the IMSI included in the registration message;
obtain the calling number associated with the IMSI from the home network associated with the IMSI included in the registration message; and thereafter
forward the incoming call for the account identifier to the calling number so that the incoming call is terminated over a cellular network.

21. The system of claim 19, wherein the processor is further configured to:
make a previous recognition determination that the internet-based telephony system has previously associated the IMSI included in the registration message with a stored calling number associated with the IMSI;
based on the previous recognition determination use the stored calling number as the calling number.

22. The system of claim 19, wherein the processor is further configured to:
make an invalidity determination that the registration message does not include a valid IMSI; and
based on the invalidity determination, send a message to the mobile telephony device to request the calling number for forwarding the incoming call.

23. The system of claim 19, wherein the processor is further configured to:
make an invalidity determination that the registration message does not include a valid IMSI; and
based on the invalidity determination, send a message to the mobile telephony device to request the calling number for forwarding the incoming call.

24. An internet-based telephony system comprising a processor configured to:
receive a registration message from a mobile telephony device, the registration number including an International Mobile Subscriber Identity (IMSI) and account identifier allocated by the Internet Protocol (IP) telecommunication service to the telephony device;
make a determination that the IMSI included in the registration message is invalid; and,
based on the determination, send a message to the mobile telephony device to request a calling number for forwarding an incoming call.

25. The method of claim 1, wherein the first SIM card is associated with a first country network and the second SIM card is associated with a second country network.

26. The mobile telephony device of claim 7, wherein the first SIM card is associated with a first country network and the second SIM card is associated with a second country network.

27. The method of claim 13, wherein the first SIM card is associated with a first country network and the second SIM card is associated with a second country network.

28. The method of claim 13, further comprising obtaining the calling number from the second network associated with the second IMSI.

29. The internet-based telephony system of claim 19, wherein the first SIM card is associated with a first country network and the second SIM card is associated with a second country network.

30. The internet-based telephony system of claim 19, wherein the processor is further configured to obtain the calling number from the second network associated with the second IMSI.

31. The method of claim 1, further comprising receiving an incoming call for the mobile telephony device over the second network when the change of the SIM card comprises the change from the first SIM card associated with the first network to the second SIM card associated with the second network.

32. The mobile telephony device of claim 7, further comprising a receiver configured, when the change of the SIM card comprises the change from the first SIM card associated with the first network to the second SIM card associated with the second network, to receive an incoming call for the mobile telephony device over the second network.
